(19) United States
(12) Patent Application Publication
(10) Pub. No.: US 2003/0074352 A1
(43) Pub. Date: Apr. 17, 2003

(54) Database query system and method

(76) Inventors: Simon D. Raboczi, Auchenflower (AU); Paul A. Gearon, The Gap (AU); David P. Hyland-Wood, Chapel Hill (AU)

Correspondence Address: STRAUB & POKOTYLO, 1 BETHANY ROAD, SUITE 83, BUILDING 6, HAZLET, NJ, 07730, US

(21) Appl. No.: 10/134,069

(22) Filed: Apr. 26, 2002

(30) Foreign Application Priority Data
Sep. 27, 2001 (AU) PR7967

(51) Int. Cl. G06F 7/00

(52) U.S. Cl. 707/4

(57) ABSTRACT

A secure distributed database management query system is disclosed. One or more knowledge stores hold data in the form of statements that represent relationships between nodes in a directed graph data structure. The statements in the database may include security information in the form of statements specifying which users are allowed access at a statement level. A query may include a FROM clause that denotes a multiplicity of knowledge stores that can be queried simultaneously.

### FIELD OF THE INVENTION

The present invention is directed to a database management system, and more particularly, to a distributed, typeless, secure database management system.

### COPYRIGHT NOTICE

A portion of the disclosure of this patent document contains material which is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### RELATED APPLICATION

Australian Patent Application No. ______ titled “COMPUTER USER INTERFACE TOOL FOR NAVIGATION OF DATA STORED IN DIRECTED GRAPHS” filed on even date herewith and naming the same inventors as the present application is hereby expressly incorporated by reference.

### BACKGROUND OF THE INVENTION

Many people want to search electronic databases to find information. Often, the information that is relevant is located in more than one database in more than one place. Often, these databases are of different types or structures, making searching difficult and time consuming.

Many electronic databases are very large, containing huge amounts of information. Often, users submit database queries that take significant time to process and to return the resultant data.

To speed processing, a query can be broken down into separate queries, that can be processed by more than one processor at the same time. However, this is complex, and often the overhead of doing this outweighs the benefits received. There are also security issues where this occurs across a number of processors.

There is a need for a secure, distributed database searching technique.

One possible solution involves using a data model that is different to the conventional relational database management system (RDMS) model. A RDMS is a system that stores information in tables (rows and columns of data) and conducts searches by using data in specified columns of one table to find additional data in another table. In a relational database, the rows of a table represent records and the columns represent fields (particular attributes of a record). In conducting searches, a relational database matches information from a field in one table with information in a corresponding field of another table to produce a third table that combines requested data from both tables.

Traditional database technology (relational, object oriented) is not suited to information management and retrieval across very large, distributed private and public online information stores. In the past, the response to this problem has been proprietary, complex and expensive “middleware” or “datawarehousing” solutions. These responses do not scale to large volumes of constantly changing, unstructured information, particularly where that information is owned by different organizations and is running on different computer platforms.

Due to the volume of data to be searched, relational databases have reached their natural limits. Relational databases were not designed for large volumes of data, particularly unstructured data (e.g., news reports).

For example, some databases of legal information, such as Lexis-Nexis, use more than five mainframes to serve 24 terabytes of documents from a single data store. There is a need for a system that will allow the same amount of information to be shared within geographically distributed entities using only PC-class hardware.

The Resource Description Framework (RDF) is a standard for describing resources on the World Wide Web. The Resource Description Framework integrates a variety of applications from library catalogs and world-wide directories to syndication and aggregation of news, software and content to personal collections of music, photos and events using XML as an interchange syntax. The RDF specifications provide a lightweight ontology system to support the exchange of knowledge on the Web.

RDF, developed by the World Wide Web Consortium (W3C), provides the foundation for metadata interoperability across different resource description communities. One of the major obstacles facing the resource description community is the multiplicity of incompatible standards for metadata syntax and schema definition languages. This has lead to the lack of, and low deployment of, cross-discipline applications and services for the resource description communities. RDF provides a partial solution to these problems via a Syntax specification and Schema specification. See Guide to the Resource Description Framework by Renato Iannella, The New Review of Information Networking, Vol 4, 1998.

RDF is based on Web technologies and, as a result, is lightweight and highly deployable. RDF provides interoperability between applications that exchange metadata and is targeted for many application areas including: resource description, site-maps, content rating, electronic commerce, collaborative services, and privacy preferences. RDF is the result of members of these communities reaching consensus on their syntactical needs and deployment efforts.

The objective of RDF is to support the interoperability of metadata. RDF allows descriptions of Web resources—any object with a Uniform Resource Identifier (URI) as its address—to be made available in machine understandable form. This enables the semantics of objects to be expressible and exploitable.

RDF is based on a concrete formal model utilizing directed graphs that allude to the semantics of resource description. The basic concept is that a Resource is described through a collection of Properties called an RDF Description. Each of these Properties has a Property Type and Value. Any resource can be described with RDF as long as the resource is identifiable with a URI.

Thus, the definition of a database as a set of subject-predicate-object triples is known. It is described in Resource Description Framework (RDF) Model & Syntax Specification, Feb. 22, 1999, which is a World Wide Web Consortium (W3C) Recommendation. See also Resource Description Framework (RDF) Schema Specification 1.0, Mar. 27, 2000.

To date, RDF has been directed primarily at public Internet search problems. RDF research has not focused on using it to provide distributed database search capabilities for commercial business applications, that require speed, robustness, and high security.

Guha specified a project to create a scalable open-source database for RDF in a paper titled “rdfDB: An RDF Database.” However, this project only implemented a simple local database which is incapable of distribution, transactions, security or inferencing. The rdfDB cannot handle distributed queries.

The statement-based approach treats relations (properties) as just another element. Most existing database formalisms (e.g. domain relational calculus [Ramez Elmasri and Shamkant Navathe, Fundamentals of Database Systems, 2nd Ed, Benjamin Cummings Publishing Company, 1994, §8.3], deductive databases [Fundamentals of Database Systems, §24.1]) treat relations as completely different from elements. These other approaches can always define a STATEMENT relation with subject, predicate and object attributes in order to represent statements; this does not make them statement-based unless they store everything in this single relation.

Thus, there is a need for a database management system that has the ability to perform concurrent distributed searches across data in many locations, works extremely quickly in producing accurate search results, is scalable to handle very large volumes of information using commodity hardware, and that has a cross platform security solution suited to distributed systems.

In short, there is a need for a better way to search large distributed databases.

### SUMMARY OF THE PRESENT INVENTION

The present invention is a distributed, typeless, secure database management system. The present invention is configured to natively store and process statements using a data model that is different from the relational database model of conventional database management systems.

In the representative embodiment of the present invention, the information is stored in a representation of a directed graph data structure. In the representative embodiment, data is stored in the form of triples composed of subject-predicate-object statements. Each statement represents a relationship between nodes in a directed graph data structure. An element will represent either a subject (possibly a Uniform Resource Locator or Identifier, URL or URI), predicate or a literal (plain text). The data to be searched can be, for example, documents comprising text or metadata regarding those documents or both.

The present invention includes a process of resolving queries by filtering the result against a FROM clause. The FROM clause can also be used to implement access control for statements. A FROM clause is a part of a query which designates the location of the data to be queried. In the case of a traditional relational database, the FROM clause typically denotes a single database instance on a single server. In the present invention, the FROM clause denotes a multiplicity of database servers which are queried simultaneously.

A user, via a user interface, initiates a query to a database server. This query may, for example, define a command to return all statements in which the term “cat” is the object. Part of the query (the FROM clause) specifies which database servers should be queried to find the answer. The receiving server (or query proxy) breaks down the query into a series of queries to each database server. This process may be made more efficient by issuing a narrowing query first, which allows each database server to report whether it holds any information of the type requested (if it does not there is no point in running the query at all). Any database servers which have results return them to the receiving server (or query proxy), where they are joined and returned to the user via the user interface.

The process of joining result sets from database servers is appropriate since joining result sets is equivalent to performing a set union on a model representation of the result sets. Each result is a set of statements upon which mathematical set operations may be performed. An algebra using set theory is disclosed herein in order to mathematically describe the mechanism used for distributed queries.

This process of defining and conducting distributed queries on a typeless data structure allows an arbitrary number of database servers to participate in a given query which, in turn, allows for very large amounts of data to be queried in a reasonable amount of time.

Since all data in a database of this form is held in statements, any metadata used by the database itself for its own internal operations are also held as statements. In the representative embodiment, security information (such as a statement that says in effect “Joe is allowed to see a statement X”) is held in this form. The database management system of the present invention can modify the FROM clause of a query from a given person, making it the intersection of the group of statements that the person requests and the group of statements which the person is allowed to see. This allows statement-level security to be implemented in a fast and efficient manner.

The present invention incorporates a statement store capable of rapidly calculating the statements it holds which satisfy a constraint.

The representative embodiment of the present invention takes advantage of the fact that RDF data is defined as a set of triples (hence all data is held in the same structure or format—this makes the database “typeless”), and this enables creation of an extremely fast retrieval engine.

In the representative embodiment of the present invention, all data is held in a single structure and is multiply indexed. Using relational database terminology to explain the present invention, the data is held in a single long table with three generic fields, which is then optimized for joins since all queries require joins. This allows queries to be performed extremely fast compared to strongly-typed relational systems in which only some of the data is indexed and it is not possible to optimize all tables for joins. Relationships between data in the database are not implicit in the storage format, as in a relational database.

As a broad example of the application of the present invention, a user wishes to search a database of documents and/or metadata to find relevant documents. In the representative embodiment, the database that is searched is not a relational database, but rather, a set of knowledge stores. The user formulates a query, and submits that query for processing. In the representative embodiment, a query engine processes the query and returns a list of nodes in the directed graph (sometimes called a list of hits) that satisfy the query. These nodes may represent documents (resource nodes) or metadata (literal nodes).

The present invention can be used in many applications, including searching documents or Web sites on the World Wide Web, to search electronic mail stores and to search extremely large databases of documents. The documents that are searched need not be of the same type. For example, one application of the present invention can search electronic mail messages, email attachments, word processing documents, Web pages and information in structured relational databases.

In short, the speed, security and distributed nature of the present invention are not found in prior large database systems. This makes the present invention highly suitable for both intranet and internet applications.

Many other features and embodiments of the present invention are described in detail below.

### BRIEF DESCRIPTION OF THE DRAWINGS

FIG. 1 is a block diagram showing typical hardware elements that operate in conjunction with the present invention.

FIG. 2 is a block diagram showing, at a high level, the software components utilized in conjunction with a representative embodiment of the present invention.

FIGS. 3A, 3B and 3C illustrate how the knowledge store of FIG. 2 can be configured.

### DETAILED DESCRIPTION

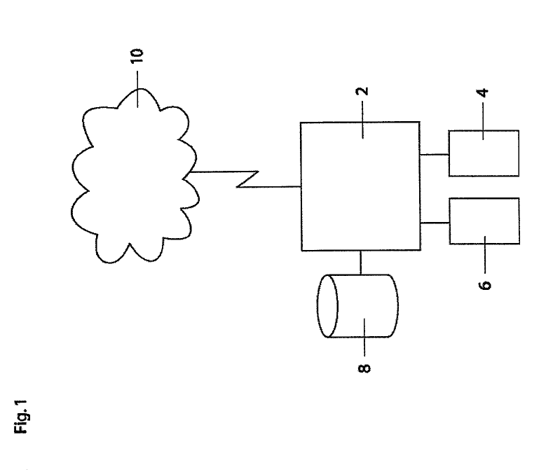

Referring now to the drawings, and initially FIG. 1, there is illustrated in block diagram form representative hardware elements used to process a representative embodiment of the present invention. An overview of an appropriate hardware configuration is described. Using this configuration, the representative embodiment of the invention can be employed.

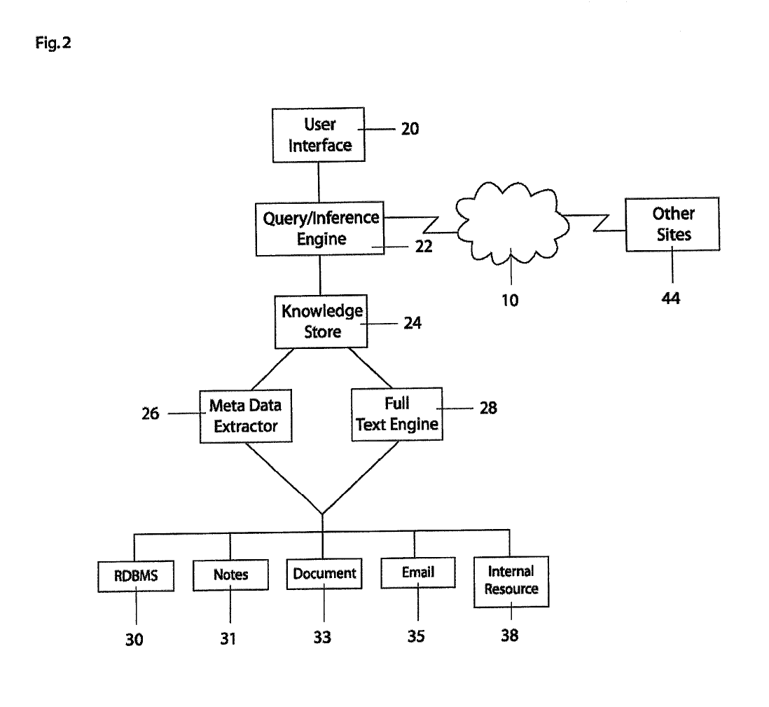

A computer processor 2 is coupled to an output device 4, such as a computer monitor. The computer monitor can display the user interface 20 of FIG. 2. The computer processor is also coupled to one or more input devices 6, such a keyboard, a mouse and/or a microphone. A user uses the input device 6 to provide input (such as queries and selections) to the computer process 2. The computer processor 2 is also coupled to one or more local electronic storage devices 8, such as a RAM, ROM, hard disk and/or a read-write DVD drive. If desirable, the local storage devices 8 can store part or all of the program logic of the present invention and/or the database of the present invention. The program logic of the present invention can be executed by the computer processor 2.

The computer processor may also be coupled to one or more computer networks 10. The computer network 10 may be a LAN, WAN, extranet, intranet or the Internet. If desirable, some or all of the program logic and/or the database of the present invention can be stored remotely on the computer network 10 and accessed by the computer processor 2.

In the representative embodiment, computer processor 2 operates a browser program, such as Netscape Navigator, which is displayed to a user on the output device 4.

Due to the nature of the software of the present invention, the exact specification of the underlying hardware is not vital for the purposes of the invention.

The computer processor 2 most commonly is part of a personal computer. However, the present invention is implemented to take advantage of new hardware platforms (such as handheld devices) as they become available. Thus, the processor 2 of this invention could be part of a dedicated desktop PC or a mobile device.

In the representative embodiment, the computer processor 2 can be used by a typical user to access the Internet and view web pages or other content, and run other application programs. Although the processor 2 can be any computer processing device, the representative embodiment of the present invention will be described herein assuming that the processor 2 is an Intel Pentium processor or higher. The storage device 8 stores an operating system, such as the Linux operating system, which is executed by the processor 2. The present invention is not limited to the Linux operating system, and with suitable adaptation, can be used with other operating systems. The representative embodiment as described herein was implemented in the Java programming language which allows execution on multiple operating systems.

Application program computer code of the present invention can be stored on a disk that can be read and executed by the processor 2.

FIG. 2 illustrates in block diagram form typical components that interact with the present invention. A user interface 20 allows a user to input queries, receive search results and otherwise communicate with and operate the present invention.

In the representative embodiment, the user interface 20 enables specification of document retrieval similarity using multiple dimensions (e.g., date, type of document, concepts, names). This promotes the rapid discovery of highly relevant information. Search terms may be exact or partial matches to metadata literals, full text index terms, and uniform resource locator (URL) pointers to original document locations.

The user interface 20 is coupled to a query/inference engine 22. The query/inference engine 22 enables disparate information sources to be collated, compared and queried based on a set of rules and facts, and inferences made on those rules and facts.

For instance, a typical search engine could find a resource with a textual-string “seal”—which may be an engine part or a mammal. The query/inference engine can determine the difference between these two “classes” of “seal”. In the representative embodiment, the query/inference engine 22 has been implemented in the Java programming language. It uses algorithms for inferring relationships from a directed graph data store. Examples of algorithms used for inferencing are the forward- or backward-chaining algorithms commonly used in expert systems. The process of inferencing is implicit and takes place following each query to assist in refining query results.

The query/inference engine 22 is coupled to a knowledge store 24. In the representative embodiment, the knowledge store 24 is a specialized database capable of searching more than fifty thousand statements per second. This is based on a data structure that is tuned to enable specialized graph queries and updates. This is not based on relational database software due to the inefficiencies in query language and network performance overheads. Relational databases have severe limitations on their ability to perform distributed queries.

The query/inference engine 22 serves as a clearinghouse for queries made against one or more knowledge stores 24. Queries which include a FROM clause designating multiple database servers are split by the query/inference engine and new queries made from there to each of the designated servers. The query/inference engine is then responsible for receiving, combining and returning the results of the query to the user interface 20.

Each query/inference engine can receive queries from a user interface 20 inclusive of user authentication credentials. User authentication credentials are typically validated using an authentication database (e.g. a Lightweight Directory Access Protocol database or system files of the local computer operating system). The details of user authentication are well-known. For distributed queries, a given user's credentials will be independently validated by each local database system prior to the processing of a query.

The knowledge store 24 is optionally coupled to both a metadata extractor 26 and a full text engine 28.

The metadata extractor 26 of the representative embodiment of the present invention combines metadata extraction tools and resolves their output into one consistent form. It can extract metadata from a variety of data sources (e.g., 30 to 38) such as files systems, email stores and legacy databases. During the extraction process individual tools perform specific tasks to discovery metadata, for example, extracting names, places, concept, dates, etc. The combination of the output of these tools produces a single metadata file that is then sent to the knowledge store 24 for persistence. Individual metadata extraction tools may be plugged into a common metadata extraction framework. Thus, these tools may be manufactured and maintained by separate organizations. The use of parallel asynchronous processing of a document by different extractors allows adaptive processing, where the nature of a document as discovered by one component can trigger other extraction components. The representative embodiment uses metadata extraction tools that can be licensed from commercial suppliers, such as Management Information Technologies, Inc of Gainesville, Fla., which makes the Readware concept extraction tool or Intology Pty. Ltd. of Canberra, Australia, which makes the Klarity metadata extraction tool.

The representative embodiment can also use proprietary and public domain metadata extraction tools.

The full text engine 28 of the representative embodiment of the present invention indexes original content such as 30, 32, 34, 36 and 38. Full text indexes can be treated as another form of metadata, allowing a query text entry box on the user interface 20 to be used simultaneously for metadata and full text searches.

The metadata extractor 26 and the full text engine 28 both access data in data stores. This data can be large volumes of constantly changing, unstructured information of different types. For example, this data can be data in a relational database 30, data in a Lotus Notes database 32 and legacy database, documents 34 stored in a file systems and memory device, such as word processing documents, RTF documents, PDF documents, and HTML documents. This data can F also be email messages in email stores 36 and Internet resources (URLs) 38.

The user interface 20, query/inference engine 22, knowledge store 24, metadata extractor 26, and full text engine 28 can all be controlled and execute upon a single processor (e.g., 2 of FIG. 1).

Other sites 44 can also include an implementation of the user interface 20, query/inference engine 22, knowledge store 24, metadata extractor 26 and full text engine 28 can include local or remote access to various other data sources of data, including large volumes of constantly changing, unstructured information of different types.

Normally, a database has a schema, where someone has defined the relevant labels for each table and row. In the present invention, no schema is necessary. Data may have a “name space” defined which provides data type information, but its use with queries is optional.

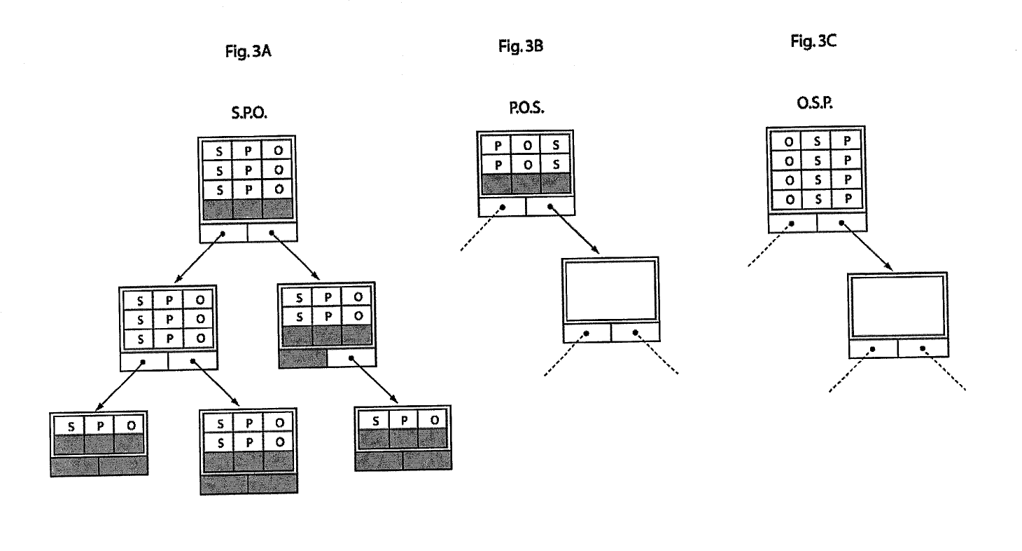

FIGS. 3A, 3B and 3C illustrate how the knowledge store 24 is configured.

The knowledge store 24 stores statements (short fixed sentences), which comprise a subject, a predicate and an object. In the representative embodiment, these statements are indexed with three parallel AVL trees (a well-known indexing method) on top of Java 1.4's new memory mapped I/O mechanism. AVL is a structure that is named for its inventors, Adelson-Velskii and Landis.

The statements in the knowledge store 24 could, for example, be Resource Description Framework (RDF) statements.

Subjects and predicates are resources. Resources may be anonymous or they may be identified by a URL. Objects are either resources or literals. A literal is a string (i.e., text).

Subjects, predicates and objects are represented in a directed graph (Graph) as positive integers called graph nodes. The node pool keeps track of which graph nodes are currently in use in the Graph so that they may be reused. The string pool is used to map literal graph nodes to and from their corresponding string values. The three graph nodes that represents a statement are collectively referred to as a triple.

FIGS. 3A, 3B and 3C illustrate the internal workings of the directed graph implementation in the knowledge store 24. Each of these three figures shows a portion of an index of a directed graph data structure implemented in a AVL tree. FIG. 3A shows the data (stored as a series of triples) sorted by the first component of the triple. In the representative embodiment, the first component of each triple represents a subject. FIG. 3B shows the same data set, this time sorted by the second component which is a predicate in the representative embodiment. FIG. 3C shows the same data set, this time sorted by the third component which represents an object in the representative embodiment. Thus it is a feature of the knowledge store's 24 directed graph data structure that the implementation consists of three indices (one for each component of a triple). The data is stored only in the indices and is not stored separately elsewhere. Storing the data three times increases the storage requirements for the data set but allows for very rapid responses to queries since each query component can use the most appropriate index.

In the representative embodiment, the Graph stores triples in three AVL tree indices. Each triple is stored in all three AVL trees, as shown in FIGS. 3A, 3B and 3C. The AVL trees each have a different key ordering, defined as follows:

(subject, predicate, object),

(predicate, object, subject) and

(object, subject, predicate).

Each node in an AVL tree comprises:

a set of triples sorted according to the key order for this tree.

the number of triples in the set for this node.

a copy of the first triple in the sorted set.

a copy of the last triple in the sorted set.

the ID of the left subtree node.

the ID of the right subtree node.

the height of the subtree rooted at this node.

All triples in the left subtree compare less than the first triple in the sorted set and all triples in the right subtree compare greater than the last triple in the sorted set.

Space for a fixed maximum number of triples is reserved for each node.

A triple is added to a tree by inserting it into the sorted set of an existing node. If the only appropriate node is full then a new node will be allocated and added to the tree.

A triple is removed from the tree by identifying the node which contains it and removing it from the sorted set. If the sorted set becomes empty then the node is removed from the tree.

AVL tree nodes are split between two files such that the sorted set of triples for a node are stored as a block in one file while the remaining fields are stored as a record in the other file. This ensures that the traversal of an AVL tree does not result in sorted sets of triples being unnecessarily read into memory. This also allows for different file I/O mechanisms to be used for the two files.

The storage structure and architecture of the representative embodiment of the present invention better reflects the unstructured complexity of the real world. It yields faster, more efficient searching. The inference framework automatically extracts, collates and relates unstructured and structured data stores from multiple locations.

The representative embodiment of the present invention is a distributed database management system based on RDF statements.

A set of RDF statements is called a model. In order to talk about models, one can assign them URIs.

Because models are sets, one can perform set operations upon them: unions, intersections, differences, etc. We can build new models from existing ones using these set operations. For example, one can use set union to define a new model which contains all the statements of two existing models.

Queries to the database management system come down to asking whether a model contains certain statements or not. Part of this involves specifying which model to query, using the clause “FROM (model)”. Part of this involves specifying the conditions the statements must satisfy, using the clause “WHERE (conditions satisfied)”.

A given physical database (statement store) has a model corresponding to all the statements stored within it. A FROM clause composed of the union between several of these models is a distributed query, and can be resolved by querying all the involved databases and aggregating the results.

In addition to the model representing all statements within it, a physical database may also have subset models which contain only some of its statements—for example, the statements obtained from a certain source, or the statements which a certain person is allowed to see.

At the very least, a model should allow one to test whether it contains a particular statement or not. The physical database is cunningly structured so that it can do more. It can quickly determine the statements within its model that satisfy a WHERE clause. This is all that needs to be done to answer a query if the FROM clause indicates that the query is made against all statements in the database.

If the FROM clause indicates that the query is against a subset model rather than the entire database, then initially all statements satisfying the WHERE clause are obtained. These statements are then individually tested for containment within the subset model, discarding those which are not present to obtain the correct answer to the query.

One use of subset models is for security. Subset models may be defined to represent those statements which a certain people are allowed to see. The database management system can then modify the FROM clause of queries from a given person, making it the intersection of the model they request and the model they are permitted to see. This will eliminate any statements from the answer which that person should not see.

The representative embodiment of the present invention is best explained using mathematical terminology. The present invention can be implemented using a new interactive query language, explained in the algebra below. (Some of the mathematical notation used herein is summarized towards the end of detailed description.)

In very broad terms, for a database query system, the input is a query and the output is the answer. The process that takes a query and provides the answer can be described in an algebra, as follows:

1. Resolution

In this section, we define what a query is, what an answer is, and a process which transforms queries into answers. Queries are generated in the user interface 20 and modified as needed in the query/inference engine 22 before being passed to the knowledge store 24 for execution.

1.1 Statements

The statement is the underlying data structure of the representative embodiment of the present invention.

E is the set of elements that participate in statements,

### Example

A possible value for E might be {birds, cats, chase, dogs, eat, fishes}.

J is the set of statement roles.

J={subject, predicate, object}

S is the set of statements.

S⊂(J→E)

A statement assigns an element to each statement role. The predicate is restricted to relations.

### Example

For the example, we define the following subset as statements.

P is the set of relations.

P⊂E

Relations are just a special kind of element.

P={chase, eat}

(Note that fishes is a collective noun, not a verb.)

S=E×P×E

S for the previous examples would contain 72 elements, including (fishes, chase, birds). Statements are abbreviated hereafter by omitting the parentheses and commas, simply as fishes chase birds.

Algebra

An element of S maps elements of J to elements of E.

SεE Sets, so it has a powerset P (S). Set union, intersection, etc form subgroups with P (S).

1.2 Statement Store

A statement store holds statements. In the representative embodiment, the statement store is located in the knowledge store 24.

H is the state variable of the statement store.

HεP (S)

Assume that H can be represented on the computer. This assumption can be satisfied if the cardinality of H is small enough that it can be explicitly stored on a filesystem, or if it is regular enough that it can be implicitly generated.

### Example

An example store might hold {cats chase birds, cats eat birds, cats eat fishes, dogs chase cats}. A statement set with such a finite cardinality can be explicitly stored.

### Example

Another example store might hold {1<2, 1<3, 2<3 . . . }. A statement set with such a regular structure can be implicitly generated.

In the representative embodiment of the present invention, the graph interface represents a statement store. The various implementations of this interface use explicit storage.

Algebra

H is a variable and therefore subject to assignment. This can be expressed using P (S) subgroup operations (union, intersection, difference, etc).

### Example

H:=H∪{dogs eat dogs} asserts/inserts the statement Dogs eat dogs.

### Example

H:=H/{dogs eat dogs} retracts/deletes the statement Dogs eat dogs.

1.3 Expressions

expr is a function that forms expression sets from a set A of expression elements and a set O of expression operations.

expr (A, O)=A∪(expr(A, O)×O×expr(A, O))

An expressions is recursively defined as either a simple expression consisting of a single expression element, or a compound expression consisting of two subexpressions joined by an expression operation.

(A, ⊙, Θ) is a commutative group [symbol] (expr(A, {⊙∪O}), ⊙, Θ) is also a commutative group

((A, ⊕, Z, Θ) is a commutative group) [symbol] ((A, \mathring{×}, I, Θ) is a commutative group) [symbol] (expr(A, {⊕, \mathring{×}}), ⊕, \mathring{×}, Z, I, Θ) is a dual field

The following map will be used in expression calculi below.

∘ maps boolean functions to set functions.

∘=[ [symbol] >∪, [symbol] >∩]

1.4 Symbol

R is the set of symbols (references).

r is the relation from a symbol to the thing it stands for.

rε(R→U

1.5 Model

The FROM clause.

In rdfDB, the FROM clause specifies a single local model (database). In the present invention, models are globally defined and the FROM clause can combine them in complex set expressions. This is significant because the complicated model expressions can be used by a client (e.g. user interface 20) to express distributed queries and by a database server (e.g. a combination of the query/inference engine 22 and the knowledge store 24) to express security constraints. This allows security constraints to be validated in a secure environment.

M is the set of models. Assume that m, m′, m″, etc are elements of this set.

M⊂R

rε(M→P(S))

Models are symbols representing sets of statements.

Models form a subdomain of symbols whose range is sets of statements.

Expression

Neither databases nor relations (tables) from relational algebra form expressions.

F is the set of FROM clauses, a.k.a model expressions.

F=expr (M, { [symbol] , [symbol] })

Disjunction allows one to express distributed queries.

Conjunction allows one to express security constraints.

Calculus

evaluates FROM clauses.

f(f′o f″) [symbol] (f f′)(o o)(f f″)

Any compound model expression can be decomposed, eventually into simple models.

f m [symbol] r m

A model evaluates to the set of statements it refers to.

Derived

fε(F→P(S))

Algebra

Z_{F} is the empty model.

f Z_{F}=Ø

The empty model includes no statements.

I_{F} is the universal model.

f I_{F}=S

The universal model includes all statements.

(M, [symbol] , Z_{F}, [symbol] ) is a commutative group.

(M, [symbol] , I_{F}, [symbol] ) is a commutative group.

(F, [symbol] , [symbol] , Z_{F}, I_{F}, [symbol] ) is a dual field.

1.6 Variable

X is the set of variables.

### Example

In the examples that follow, x, y and z are variables.

In the interactive syntax of the present invention, variables include $x, $y, $z, $title, etc.

1.7 Solution

The GIVEN clause.

B is the set of solutions (variable bindings).

B=(X→E)

A solution is a mapping from a variable to a value.

### Example

A typical solution might be x>cats

Expression

G is the set of GIVEN clauses, a.k.a. solution expressions.

G=expr (B, { [symbol] , [symbol] })

This is the analogue of the table (relation) from relational algebra. A term (expression composed using [symbol] operations) is equivalent to a relational table row, or to an instantiation from a deductive database. Unlike the table, there is a set of solutions rather than a sequence of table rows (i.e. no ordering, no duplicates).

Disjunction allows one to express multiple solutions.

This is the analogue of the table append operation of relational algebra.

Conjunction allows one to express solutions with more than one variable.

This is the analogue of the natural join operation of relational algebra.

### Example

A typical solution expression could be ([×>cats] [symbol] [y>birds]) [symbol] ([x>dogs] [symbol] [y>cats]).

Algebra

Z_{G} is the empty solution. It includes no solutions.

I_{G} is the universal solution. It includes all solutions.

(B, [symbol] , Z_{G}, [symbol] ) is a commutative group.

(B, [symbol] , I_{G}, [symbol] ) is a commutative group.

(G, [symbol] , [symbol] , Z_{G}, I_{G}, [symbol] ) is a dual field.

In addition to the dual field postulates, note the following.

g [symbol] g=g

g [symbol] g=g

[x>e] [symbol] [x>e′]=Z_{G}

1.8 Constraint

The WHERE clause.

The WHERE clause is modified as needed in the query/inference engine 22 and executed in the knowledge store 24. This is the analogue to the select operation σ from relational algebra.

C is the set of constraints (statement store queries) Assume cεC wherever it occurs.

C=(J→{X∪E})

A constraint assigns a variable or value to each statement role.

### Example

A possible constraint c would be [subject>cats, predicate>eat, object>x], which is abbreviated to cats eat x. This means that x is constrained to be things that cats eat.

Expression

W is the set of WHERE clauses, a.k.a constraint expressions

W=expr (C, { [symbol] , [symbol] })

### Example

A possible constraint expression might be (x chase y) [symbol] (y chase z).

Calculus

c converts a constraint to the set of statements satisfying that constraint.

cε(C→P(S))

For each jεJ of the domain of the parameter c, it re-maps the range to S j for elements xεX and to {c j} for elements eεE.

### Example

The c c corresponding to the previous query What do cats eat? would be {cats}×{eat}×E.

The interactive query language of the present invention uses XPath expressions to define sets other than E when forming the constraint set. (XPath is explained in XML Path Language (XPath) Version 1.0, Nov. 16, 1999. XPath is a W3C Recommendation.)

Algebra

Z_{W} is the empty constraint.

c Z_{W}=S

All statements satisfy the empty constraint.

I_{W} is the universal constraint.

c I_{W}=Ø

No statement satisfies the universal constraint.

(C, [symbol] , Z_{W}, [symbol] ) is a commutative group.

(C, [symbol] , I_{W}, [symbol] ) is a commutative group.

(W, [symbol] , [symbol] , Z_{W}, I_{W}, [symbol] ) is a dual field.

1.9 Query

The query.

Q is the set of queries.

Q=F×W×G

A query has a FROM, WHERE and GIVEN clause.

### Example

Typical queries would include (I_{G}, I_{F}, (x chase y) [symbol] (y eat z)).

A is the set of answers.

A=F×{Z_{W}}×G

An answer is a query with the empty constraint as its WHERE clause.

Derived

A⊂C

### Example

A possible answer for the preceding query is (m [symbol] m′, Z_{W}, [x>dogs, y>cats, z>birds] [symbol] [x>dogs, y>cats, z>fishes]). In other words, there are two solutions. The statements used to produce these solution come from either of the two models m or m′.

Algebra

Queries form groups with all constraint expression operations.

q [symbol] q′=(f, w, g) [symbol] (f′, w′, g′)=(f [symbol] f′, w [symbol] w, g [symbol] g′)

q [symbol] q′=(f, w, g) [symbol] (f′, w′, g′)=(f [symbol] f′, w [symbol] w′, g [symbol] g′)

The following definitions make the calculus work.

resolve′ε(C×S→expr (B, { [symbol] }))

For each parameter (c, s) where the range of c is in X, calculate c j>s j. These are elements of B. Conjoin ( [symbol] ) all these intermediate results with I_{G} to generate the product.

The following examples communicate the function of resolve′:

1) The function determines the variable bindings required to make a constraint match a statement. For example:

c=$x chase $y=subject>$x & predicate>chase & object>$y

s=dogs chase cats=subject>dogs & predicate>chase & object>cats

result=$x>dogs & $y>cats

2) If the constraint matches the statement without any bindings required, the result of the function is I_{G} For example:

c=dogs chase cats

s=dogs chase cats

result=I_{G}

3) If no set of variable bindings can make the constraint match the statement, the result of this function is Z_{g}. For example:

c=$x eat $y

s=dogs chase cats

result=Z_{g}

resolveε(C×P(S)→G)

Use the constraint to map a statement (indexed on J) For every parameter (c, s) calculate c resolve′ s. Disjoin ( [symbol] ) all these intermediate results with Z_{G} to generate the product.

The function of resolve is to apply resolve′ to each statement in a set of statements and OR the results. For example:

c=$x chase $y

H={dogs chase cats, cats chase mice, cats eat birds}

result=($x>dogs & $y>cats) OR ($x>cats & $y>mice) OR Z_{G}

Because “something OR Z_{G}” simplifies to just “something”, we can reduce this to just ($x>dogs & $y>cats) OR ($x>cats & $y>mice).

Calculus

q is the function resolving queries to answers.

q(f, wow′, g) [symbol] q(f, w, g)o q(f, w′, g)

A query with a compound WHERE clause can be factored into a series of queries with simpler WHERE clauses. Repeated application of this rule can eventually lead to a series of queries with WHERE clauses containing individual constraints. The results of each of the simple queries can then be combined to return the correct answer for the original (compound) query.

q(f, c, g) [symbol] (f, z_{w}, g [symbol] (c resolve(f f ∩c c)))

An individual constraint can be evaluated to an answer.

The knowledge store 24 in the representative embodiment can directly evaluate the set of statements H∩c c. Another method is then used to intersect these with f f, one statement at a time. Assuming f f⊂H, this correctly generates f f∩c c.

The present invention includes a novel process of resolving queries by filtering the result against a FROM clause f.

The present invention has a triple store capable of rapidly calculating the statements held which satisfy a constraint (H∩c c) when H is large (of the order of 10⁷ statements).

qε(Q→A)

Because the non-recursive rule produces an empty constraint, the calculus returns an element of A.

### Example

The example query resolved against the example statement store would result in the answer {cats eat birds, cats eat fishes}.

2. Distribution

The present invention enables distributed queries. For example, queries can be split into parts and distributed to more than one processor for processing. A query that cannot be completed locally can be sent to other systems for completion. The query is split and sent to other systems by the query/inference engine 22. It is important to be able to properly split and combine when doing distributed processing.

This section discloses the concept of separate naming contexts. This is an improvement on prior art in two important ways:

1. Elements can be transformed into more easily processed forms. This improves computational efficiency.

### Example

Instead of dealing with named symbols (e.g. birds) processing can be done on an equivalent numbers. The numbers take less space and are more quickly sorted and searched.

Java int primitives (32-bit integers) are used for all computation- and memory-intensive operations in the A s representative embodiment. Other implementations are possible, including one which uses 64-bit integers.

2. Elements can be transformed into globally unique forms. This permits distribution.

### Example

Instead of dealing with a locally defined symbol (e.g. the file/foo/bar.txt), a fully qualified URI well-defined over the entire internet can be used (e.g. file://site.net/foo/bar.txt).

URIs and XML document fragments (including text nodes) are used for distributed operations.

2.1 Names

N is the set of naming contexts. Assume nεN wherever it occurs.

### Example

The World Wide Web is a naming context.

0 is an element representing the World Wide Web.

0εN

URI

One can describe universal resource identifiers as follows.

R₀ is the set of URIs.

### Example

Typical URIs include the following.

http://www.mysite.com/doc.html

mailto:account@mysite.com

Derived

r₀ is the relation from URIs to the things they label.

2.1.1 RDF

R₀ is the set of RDF Resources

The set of RDF resources is the set of named resources (URIs) plus the set of anonymous resources. R₀ has been defined twice, as a different set each time.

L₀ is the set of RDF Literals

P₀ is the set of RDF Properties

P₀⊂R₀

E₀ is the set of RDF nodes.

E₀=R₀∪L₀

S₀ is the set of RDF Statements

S₀⊂R₀×P₀×E₀

Statements have a resource-valued subject, a property-valued predicate, and a node-valued object. Additional type constraints are what make the set of RDF statements a subset of the full Cartesian product.

The representative embodiment of the present invention uses the World Wide Web as a global naming context, and defines a local naming context for each knowledge store.

2.1.2 DBMS

In the representative embodiment, the DBMS is implemented as the combination of the query/inference engine 22 and the knowledge store 24.

D is the set of local naming contexts (DBMSes). Assume dεD wherever it occurs.

D⊂N

E_{d} is the set of Java int primitives. There are 2³² elements in this set.

S_{d}=(J→E_{d})

Models in local databases are RDF resources.

M₀=∪d(r₀ M_{d})

The set of RDF models contains the URIs of every local model.

M₀⊃r₀d

Every local database is itself a model.

m_{d}ε(M_{d}→P(H_{d}))

A model local to d corresponds to a subset of the triples in that DBMS.

m_{d}(B_{d}⁰·r₀d) is the set of all triples occurring in d.

m_{d}(B_{d}⁰·r₀d)⊃m_{d}(m_{d})

All models in d are subsets of the triples occurring in d.

f_{d}ε(F_{d}→P(m_{d}(B₀^{d}·r₀d))

FROM clauses evaluate to subsets of triples occurring in d.

Algebra

We require queries to form groups with model expression operations.

B_{n′}ⁿ·maps nodes from n to n′.

This is a bijection.

### Example

B₀^{d}·globalizes, a.k.a maps nodes from d to 0.

This is an injective (one-to-one) function.

B_{d}⁰·localizes, a.k.a maps nodes from 0 to d.

This is a surjective (onto) function.

This can be a bijection (despite the fact that it maps from the infinite set E₀ to the finite set E_{d}) as long as new elements can be added to E_{d} for any E₀ for which the knowledge store 24 didn't previously have a node. When E_{d} runs out of elements, queries will fail.

2.2 Query

Modify the query resolution calculus as follows.

q₀(f′o f″, w, g) [symbol] q₀(f′, w, g)o q₀(f″, w, g)

This is the call where the present invention breaks the FROM clause into subexpressions, looking for ones that are defined within a single knowledge store 24. Ideally, this should not be used if B_{d}⁰·f exists; in other words, the model expression should contain models from more than one knowledge store 24.

The present invention includes a novel process of breaking a query into separate queries that can be distributed. In the case of the representative embodiment, this is done by the query/inference engine 22.

q₀(f, w, g) [symbol] B₀^{d}·q_{d}(B_{d}⁰·f, B₀^{d}·w, B₀^{d}·g) if fεB₀^{d}·F_{d}

In the representative embodiment, this is a Remote Method Invocation (RMI) call or a Simple Object Access Protocol (SOAP) message. For this to be possible, B_{d}⁰·f must exist; in other words, the model expression must only contains models within the single DBMS d. It should actually execute on the remote database 44, not the connector. Note that localizing the FROM clause means that the unity element for any union operator becomes the resource referring to the local knowledge store 24. This element is very likely to occur, and the group properties of unity can be used to simplify the expression.

q_{d}(f, w′o w″, g) [symbol] q_{d}(f, w′, g)o q_{d}(f, w″, g)

This is the call where the present invention breaks the WHERE clause into individual constraints.

q_{d}(f, c, g) [symbol] (f, Z_{w}, g [symbol] (c resolve(f_{d} f∩c_{d} c))

This is the call that invokes the triple store to resolve away a constraint.

3. Security

The query algebra can enforce access security for statements by organizing the statements into models and then enforcing access security on the models. In the representative embodiment, this takes place in the query/inference engine 22 and the knowledge store 24. This can be done as follows.

3.1 Authentication Data

K is the set of authentication data.

In the representative embodiment, this information is held in a Java Authentication and Authorization Service (JAAS) object.

k_{d} is the access control function for DBMS d.

k_{d}ε(K→F_{d})

The access control function maps authentication data to the model (set of statements) to which access is granted.

This is defined using a JAAS-extended Java policy file. Each models have a JAAS Subject.

3.2 Query

Replace the RMI call from the resolution calculus with the following.

q₀(f, w, g) [symbol] B₀^{d}·q_{d}(k_{d} k [symbol] (B_{d}⁰·f), B₀^{d}·w, B₀^{d}·g)

The present invention uses the FROM clause to implement access control for statements.

The implementations described above do not need to construct an index from the documents using the identifiers in the search result. This simplifies processing.

The present invention can successfully operate without the need for a relational database structure or a hierarchical database of records. (As discussed above, the nodes of the representative embodiment are not arranged hierarchically.)

As can be seen from the description above, the representative embodiments of the present invention does not analyze documents directly, but focuses on the metadata. The metadata may include some or all of the document itself, as well as full text indices of the document. Nevertheless, inferencing is performed by analyzing relationships between nodes in a directed graph and not by directly performing linguistic or lexical analysis on a source document. Analysis of a source document by those or other means may take place during metadata extraction.

Unlike prior systems that require documents to be stored in a datastore and that each document be bound to at least one topic, the representative embodiment of the present invention requires no such restriction. Documents may or may not be held in database and, if documents are held, they need not be bound to topics.

The present invention can be used for a number of practical functions. For example, one embodiment of the present invention is a computerized search tool for discovering relationships between electronic mail messages in a message store 36. Metadata representing message headers, concepts, key words and full text indices are placed in a directed graph data structure. The directed graph structure is one component of the knowledge store, 22, shown in FIG. 2. These metadata are used to represent each message in a store 36. A directed graph (non-relational and non-hierarchical) database is used to store the metadata and make it available for query via the query language. This representative embodiment of the present invention allows a user to search the metadata in order to determine relationships that exist between metadata sets representing various messages in the store 36.

This implementation is particularly useful as an email discovery tool for use by a litigator who is required or desires to review a large number of email messages. This representative implementation can mine email boxes in any format (e.g., Microsoft Exchange, Lotus Notes, Groupwise, mbox, etc.). It can classify emails referring to key issues input or selected by the user. Optionally, this representative implementation can be interfaced with an electronic legal thesaurus to provide intelligent concept searching. It can present information in a way to allow the user to follow issues within discussion threads. It can build chronologies of email activity and graphs to show intensity of traffic between individuals over a period of time related to specific topics.

According to this representative implementation, a user enters search criteria, and identifying information for those emails in the store 36 that satisfy the criteria are displayed in the user interface 20. Terms similar to the search term can also be displayed along with the number of emails that satisfy those terms. Once an email message is selected by the user, properties of that email are displayed, such as date, to, cc, from, subject, concept, legal issues, attachments, size and named people and places. These properties are automatically captured and displayed to the user in the user interface 20 to support further searching. The user can select or deselect these properties, and other similar emails are determined by reference to the selected properties.

Another representative implementation of the present invention is an application that holds metadata related to more general documents in a document store. In this implementation, either metadata nodes or document nodes in the directed graph may be displayed to the user at the user interface 20. If a document node is displayed, the original document is shown along with its associated metadata and a list of links to related documents. The list of related documents is calculated based on the selection of associated metadata.

This representative implementation can be used, for example, to search a wide variety of documents and for many different applications. For example, it can be used to search published patent databases, databases of court decisions and statutes, databases of publications and newspaper articles, collections of Web pages and/or Web sites, and files on file servers of a large corporation or government department.

Thus, the present invention has the ability to perform concurrent distributed searches across data in many locations, work extremely fast in producing accurate search results, is scalable to handle very large volumes of information using commodity hardware, and has a cross . platform security solution suited to distributed systems. The present invention is an ideal replacement for costly middleware and datawarehousing techniques. Use of the present invention will enable more relevant information to be retrieved, because RDF goes beyond structured query languages and full text searches to support concept searching and automatic inferencing of related information. The knowledge store 24 of the present invention better reflects the unstructured complexity of real world knowledge.

The present invention can be implemented on a single personal computer, but it can also handle distributed queries across many processors. These processors need not be high end mainframes, but may be standard personal computers.

The present invention has been described above in the context of a number of specified embodiments and implemented using certain algorithms and architectures. For example, the representative embodiment has been described in relation to RDF. But the RDF implementation of the present invention is only an example of one possible implementation. The present invention is of general applicability and is not limited to this application. While the present invention has been particularly shown and described with reference to representative embodiments, it will be understood by those skilled in the art that various changes in form and details may be made without departing from the spirit and scope of the invention.

Appendix A

Mathematical Prerequisites

Group

If we claim to have a group (A, ⊙, I, Θ) then this is equivalent to the following claims. Assume a, a′ and a″ are elements of A.

Closure

a⊙a′εA

Associative Law

(a⊙a′)⊙a″=a⊙(a′⊙a″)

Identity

a⊙I=I⊙a=a

Inverse

ΘaεA

a⊙(Θa)=(Θa)⊙a=I

If we claim a commutative group, add the following.

Commutative Law

a⊙a′=a′⊙a

### Example

(Z, +, 0, −) is a commutative group. − is unary arithmetic negation rather than arithmetic subtraction or set difference.

Ring

If we claim to have an ring (A, ⊕, \mathring{×}, Z, I, Θ) then this is equivalent to the following claims. Assume a and a′ are elements of A.

(A, ⊕, Z, Θ) forms a commutative group.

Additive Closure

a⊕a′εA

Additive Commutative Law

a⊕a′=a″⊕a

Additive Associative Law

(a⊕a′)⊕a″=a⊕(a′⊕a″)

Additive Identity (Zero)

a⊕Z=Z⊕a=a

Additive Inverse

ΘaεA

a⊕(Θa)=(Θa)⊕a=Z

The multiplicative operation \mathring{×} has the following properties.

Multiplicative Closure

a\mathring{×}a′εA

Multiplicative Associative Law

(a\mathring{×}a′)\mathring{×}a″=a\mathring{×}(a′\mathring{×}a″)

The following additional laws hold between the additive and multiplicative operations.

Distributive Law

a\mathring{×}(a′⊕a″)=(a\mathring{×}a′)⊕(a\mathring{×}a″)

(a′⊕a″)\mathring{×}a=(a′\mathring{×}a)⊕(a″\mathring{×}a)

Integral Domain

If we claim a integral domain (A, ⊕, \mathring{×}, Z, I, Θ) then we have a ring with the following additional postulates.

The multiplicative operation \mathring{×} does not quite form a commutative group, because it isn't required to have an inverse.

Multiplicative Commutative Law

a\mathring{×}a′=a′\mathring{×}a

Multiplicative Identity (Unity)

a\mathring{×}I=I\mathring{×}a=a

The following additional laws hold between the additive and multiplicative operations.

Multiplicative Annihilator (Zero)

a\mathring{×}Z=Z\mathring{×}a=Z

Cancellation Law

(a\mathring{×}a′=a\mathring{×}a″)⇄(a=Z) [symbol] (a′=a″0

### Example

(Z , +, ×, 0, 1, −) is an integral domain. In this case, × is arithmetic multiplication rather than Cartesian product; − is unary arithmetic negation rather than arithmetic subtraction or set difference.

Field

If we claim a field (A, ⊕, \mathring{×}, Z , I, Θ, *) then we have an integral domain with the following additional postulates.

The multiplicative operation \mathring{×} still does not quite form a commutative group, because it isn't required to have an inverse for zero.

Multiplicative Inverse

*aεA for any a except Z

a⊕(*a)=(*a)⊕a=I

### Example

(Q, +, ×, 0, 1, −, reciprocal) is a field. × is arithmetic multiplication rather than Cartesian product; − is unary arithmetic negation rather than arithmetic subtraction or set difference.

Dual Field

If we claim a dual field (A, ⊕, \mathring{×}, Z, I, Θ), then (A, ⊕,\mathring{×}, Z, I, Θ, Θ) is a field and the dual (A, \mathring{×}, ⊕, I, Z, Θ, Θ) is also a field.

The multiplication operation \mathring{×} is (by duality) a commutative group.

Derived

The following laws are implied for the dual to be a field.

Multiplicative Identity (Unity)

a\mathring{×}=I\mathring{×}a=I

Multiplicative Inverse

a\mathring{×}(Θa)=(Θa)\mathring{×}a=I

Additive Annihilator (Zero)

a\mathring{×}Z=Z\mathring{×}a=Z

Dual Cancellation Law

(a⊕a′=a⊕a″)⇄(a=I) [symbol] (a′=a″)

Duel Distributive Law

a\mathring{×}(a′\mathring{×}a″)=(a⊕a′)\mathring{×}(a⊕a″)

(a′⊕a″)\mathring{×}a=(a′\mathring{×}a)⊕(a″\mathring{×}a)

The following additional results can be derived via the inverses and cancellation laws.

Conjugate Inverses

ΘI=Z

ΘZ=I

### Example

(Bits, [symbol] , [symbol] , false, true, [symbol] ) is a dual field.

Maps

Let's define relations from scratch.

Mappings is the set of ordered pairings of elements.

>is the mapping operator.

>εU×U→Mappings

The LHS is the parameter; the RHS is the product.

Maps is the set of sets of mappings.

A literal map is indicated using [, ] with the index set isomorphic to some range of the natural numbers.

→is the map operator.

→εU×U→Maps

The LHS is the domain; the RHS is the range.

### Example

{A, B}→{C, D}={[A>C, B>C], [A>C, B>D], [A>D, B>C], [A>D, B>D]}

Sets

The following elements from set notation will be used.

ε is the set membership operator.

Sets is the set of all sets.

A set is something that can appear as the RHS of the membership operator. A literal set is indicated using {,}.

U is the universal set.

The set that contains all elements, including all other sets.

Ø is the empty set.

The set that contains no elements.

∪ is the set union operation.

∪εSets×Sets→Sets

Commutative group operation on any set.

∩ is the set intersection operation.

∩εSets×Set→Sets

Commutative group operation on any set.

/ is the set difference operation.

/ εSets×Sets→Sets

Group operation on any set.

⊂ is the subset relation.

### Example

{A, C}⊂{A, B, C}

P is the power set function.

PεSets→Sets

The set of all subsets of the operand;

### Example

P({A, B})={Ø, {A}, {B}, {A, B}}

Sequences

Seqs is the set of all sequences.

A sequence is something that can be indexed by elements of one set to obtain elements of another set. A literal sequence is indicated using (,) with the index set isomorphic to some range of the natural numbers.

x is the Cartesian product.

xε(U×U)→Seqs

The set containing all sequences whose first element is an element of the LHS and whose second element is an element of the RHS.

### Example

{A, B}×{C, D}={(A, C), (A, D), (B, C), (B, D)}

Note that the arity need not be fixed at 2.

Boolean Algebra

Bits is the set of truth values.

Bits={true, false}

[symbol] is negation.

[symbol] is disjunction.

is conjunction.

What is claimed is:

1. A distributed database management query method for processing a query, comprising the steps of:
receiving a query, the query including a designation of a plurality of databases to be queried, each of the databases holding data in the form of statements that represent relationships between nodes in a directed graph data structure;
splitting the query into subqueries;
providing each subquery to one of the plurality of databases;
at each database, processing the subquery to produce an intermediate result that satisfies the subquery; and
combining the set of intermediate results to produce a result for the query.

2. The method of claim 1 wherein each query is a query against a set of statements and the query is composed of set operations and labelled sets of statements.

3. A distributed database management query method for processing a query, comprising the steps of:
providing a plurality of databases, each of the databases holding data in the form of statements that represent relationships between nodes in a directed graph data structure;
receiving a query, the query including a designation of which of the plurality of databases are to be queried;
splitting the query into subqueries;
providing each subquery to one of the plurality of databases as specified in the query;
at each database that receives a subquery, processing the subquery to produce an intermediate results that satisfies the subquery; and
combining the set of intermediate results to produce a result for the query.

4. A distributed database management query system for processing a query, comprising:
a plurality of database servers, each of the database servers including a database holding data in the form of statements that represent relationships between nodes in a directed graph data structure;
means for receiving a query, the query including a designation of which of the plurality of database servers are to be queried; and
a query engine communicatively coupled to each of the plurality of database servers, the query engine splitting the query into subqueries and providing each subquery to one of the plurality of database servers in accordance with the query;
wherein, each database server that receives a subquery processes the subquery to produce an intermediate result that satisfies the subquery and provides the intermediate result to the query engine, and the query engine combines the set of intermediate results to produce a result for the query.

5. The system of claim 4 wherein each query is a query against a set of statements and the query is composed of set operations and labelled sets of statements.

6. The system of claim 4, wherein each database further comprises statements that comprise security information.

7. A secure, distributed database management query method for processing a query, comprising the steps of:
receiving a query, the query including a designation of a plurality of database servers to be queried, each of the database servers including a database holding data in the form of statements that represent relationships between nodes in a directed graph data structure, the data including security information in the form of statements specifying which users are allowed access at a statement level;
splitting the query into subqueries;
providing each subquery to one of the plurality of database servers;
at each database server, processing the subquery to produce an intermediate result that satisfies the subquery and complies with the security information; and
combining the set of intermediate results to produce a result for the query.

8. A secure distributed database management query system for processing a query, comprising:
a plurality of database servers, each of the database servers including a database holding data in the form of statements that represent relationships between nodes in a directed graph data structure, the data including security information in the form of statements specifying which users are allowed access at a statement level;
means for receiving a query, the query including a designation of which of the plurality of database servers are to be queried; and
a query engine communicatively coupled to each of the plurality of database servers, the query engine splitting the query into subqueries and providing each subquery to one of the plurality of database servers;
wherein, each database server that receives a subquery processes the subquery to produce an intermediate result that satisfies the subquery and complies with the security information, and provides the intermediate results to the query engine, and the query engine combines the set of intermediate results to produce a result for the query.

9. A secure database management query method for processing a query, comprising the steps of:
providing a knowledge store including a database holding data in the form of statements that represent relationships between nodes in a directed graph data structure, the data including security information in the form of statements specifying which users are allowed access at a statement level;
receiving a query;
at the knowledge store, processing the query to produce a result that satisfies the query and complies with the security information; and
outputting the result for the query.

10. A secure database management query method for processing a query, comprising the steps of:
providing a knowledge store including a database holding data in the form of statements that represent relationships between nodes in a directed graph data structure, the data including security information in the form of statements specifying which users are allowed access at a statement level;
receiving a query from a user requesting information in the database;
modifying the query to include a security condition associated with the user;
at the knowledge store, processing the query to produce a result that satisfies the query and complies with the security condition; and
outputting the result for the query.

11. The method of claim 8, wherein the step of processing the query to produce a result that satisfies the query and complies with the security condition further comprises the steps of:
ascertaining a first set of statements in the database that satisfies the query formulated by the user;
ascertaining a second set of statements in the database that satisfies the security condition in accordance with the security information in the database; and
intersecting the first set of statements and the second set of statements to produce the result.

12. A secure database management query system for processing a query, comprising:
a knowledge store including a database holding data in the form of statements that represent relationships between nodes in a directed graph data structure, the data including security information in the form of statements specifying which users are allowed access to statements at a statement level; and
means for processing the query to produce a set of statements that satisfy the query and comply with the security information.

13. The system of claim 12 wherein each query is a query against a set of statements in a knowledge store and the query is composed of set operations and labelled sets of statement.

14. The system of claim 12 wherein the database comprises a database of metadata.

15. The system of claim 14 further comprising:
one or more data sources; and
a metadata extractor communicatively coupled to the one or more data sources and the knowledge store, wherein the metadata extractor extracts metadata from the data in the one or more data sources and provides the extracted metadata to the knowledge store.

16. The system of claim 15 further comprising a full text engine communicatively intercoupling the one or more data sources and the knowledge store.

17. A database management query system for processing a query, comprising:
a knowledge store including a database holding data in the form of statements that represent relationships between nodes in a directed graph data structure; and
means for processing the query to produce a set of statements that satisfy the query,
wherein each query is a query against the set of statements in a knowledge store and the query is composed of set operations and labelled sets of statement.
